(19) United States
(12) Patent Application Publication
(10) Pub. No.: US 2005/0102185 A1
(43) Pub. Date: May 12, 2005

(54) Event process handling

(76) Inventors: Graham Barker, Warwickshire (GB); Robert Mark Pilkington, Oxford (GB)

Correspondence Address: STEVENS & SHOWALTER LLP, 7019 CORPORATE WAY, DAYTON, OH, 45459-4238, US

(21) Appl. No.: 10/433,597

(22) PCT Filed: Nov. 30, 2001
(86) PCT No.: PCT/GB01/05310

(30) Foreign Application Priority Data
Nov. 30, 2000 (GB) 0029226.8

(51) Int. Cl. G06F 17/60

(52) U.S. Cl. 705/26

(57) ABSTRACT

An on-line multi-channel workflow processing system (10) for managing and monitoring the progression of a complex multi-event and multi-user process is described. The system operates over standard Internet protocols and is accessible via the Internet (16) and includes a data capturing engine for capturing events requested by a first user, the data capturing engine being arranged for each event to create and store an event record (160). The system (10) also includes means for implementing at least some of the events automatically (44) and means (32) for listing the event record (160) of each event which requires manual interaction for completion and which has yet to be completed. The system (10) further includes means for updating the event record (160) when a second user has manually progressed the event towards completion.

### FIELD OF THE INVENTION

The present invention concerns improvements relating to event process handling and more particularly, though not exclusively, to an on-line multi-channel workflow processing system for managing and monitoring the progression of a complex multi-event process, such as part of a complex purchasing process for a multi-dimensional item such as a vehicle. The present invention also concerns an improved search engine for use in such a system.

### BACKGROUND OF THE INVENTION

The management of a complicated purchasing process, such as a new or used car purchase by an individual, is a complex task because of the many actors and variables which are involved and the lengthy time scale for completion a transaction from initial enquiry through to order and onto delivery for new cars. Such processes become even harder to manage when there are multiple individuals involved (as purchasers) for each vendor.

These types of processes have in the past been carried out discontinuously with a customer visiting a showroom several times to view new stock, perhaps requesting a brochure, valuing their existing vehicle for part-exchange, and subsequently telephoning in to arrange a test drive. Typically, they will also require the latest price range and cost of extras. All of this information is provided in printed format for the customer to take home and consider in their own time. The cost-of supplying all this literature is significant. Also quite often a showroom will run out of stock of literature or it will become quickly out of date causing further difficulties to the dealer and customer alike.

The skill of the salesperson in remembering the customer on their various visits along the path to making a purchase is paramount. However, often this is wholly inadequate to the customer as different salespeople may be working at the time the customer chooses to visit. This results in a vast amount of repetition of conversation in bringing the new salesperson up to speed with the customer's objectives, likes and dislikes. From the salespersons position there is also an added burden of trying to remember what the customer wanted, had previously considered and disliked. This is particularly the case where the customer has not made up their mind and needs to consider various different options as this may result in the customer coming into the showroom many times and to search the latest database of cars offered by the dealer.

There are also difficulties in trying to manage this complicated purchasing process. It is very difficult for managers to assess the effectiveness of initiatives and to view performance of the company in anything other than hard sales. There is at present no quantifiable way of analysing how customer preferences are being formed or changed. Any analysis that does exist can take months to collate and analyse by which time market conditions may have changed drastically. Furthermore, analysing groups of dealerships in the subtleties of customer behavior and attitudes becomes almost impossible because of the nature of such complex purchasing processes.

It is desired to overcome or at least substantially reduce the above described problems associated with the prior art.

### SUMMARY OF THE INVENTION

According to one aspect of the present invention there is provided an on-line multi-channel workflow processing system for managing and monitoring the progression of a complex multi-event process, the system comprising: means for capturing events requested on-line by a first user, the capturing means being arranged for each event to create and store an event record; means for implementing at least some of the events automatically; means for listing the event record of each event which requires manual interaction for completion and which has yet to be completed; and means for updating the event record when a second user has manually progressed the event towards completion.

By capturing and progressing events in this way, a useful log of information is built up which enables detailed qualitative analysis to be carried out. The on-line nature of the system means that it is accessible to the user at home as well as a t the showroom.

This removes some of the burden from the sales personnel and means that some of the investigative parts of the purchasing process can be implemented by the user from his home computer.

The term complex multi-event process is intended to mean a process which can take months to complete which typically has several distinct stages and is of a sufficient value to make tracking and status issues worthwhile.

Preferably the implementing means and updating means are arranged upon completion of an event to update the event record in real time. This advantageously means that a real-time accurate view of the leads and sales being progressed can be obtained.

This division of the system is preferably into two distinct mechanisms allows for easy subdivision of processes (carried out at the processing units of the system), front-end request display (implemented via personal pages of the system) and output (also implemented via personal pages of the system). It also gives a common structure for reporting, with the business being able to measure exact timing and responses for each business event.

Real time control of events is preferably carried out by a Customer Relations Controller (CRC), a separate framework unit that links into the full application. Its purpose is to route summaries of applicable events to business users located anywhere in the enterprise. It then controls their permission to access an event access and progression code (BFU's) depending on their permissions and applicable locations. With appropriate rights, the CRC then allows a user to continue an event after selection. It therefore acts as both a timestamped log and event router which gives the present invention its unique multi-location real-time capabilities. The CRC inherently provides a monitoring capability for a multi-user enterprise.

The system may further comprise a broker logic module for determining the permission of the first user and the second user to access and update different events. This advantageously enables there to be many different types of user on the system each being controlled as to what they can do in terms of accessing and progressing events. The combination of the dynamic CRC and broker logic module make it easy to add new functionalities (events) to the system which immediately inherit the workflow and enterprise routing capabilities of the CRC framework. The whole CRC framework is highly dynamic and can be used to control differing events in future applications written to these methods.

The system preferably further comprises a database of stored permissions relating to each user and to each type of event, the broker logic module being arranged to access the database to determine the permissions. This is preferable in that the updating and maintenance of the permissions becomes relatively easy.

The present invention also extends to a method of implementing an on-line multi-channel workflow process for managing and monitoring the progression of a complex multi-event process, the system comprising: capturing events requested on-line by a first user, the capturing step comprising creating and storing an event record for each event implementing at least some of the events automatically; listing the event record of each event that requires manual interaction for completion and which has yet to be completed; and updating the event record when a second user has progressed the event towards completion.

An exemplary embodiment of the present invention, which has been applied to the field of automotive sales, hereinafter referred to as the Integrated Showroom System, has a number of advantages over the ‘classic system’ currently being used. The present invention provides a system in which it is easier to obtain, and enter, all customer details, it has improved database management, and has the ability to provide access to a substantial range of useful motoring information. Also one of its key attributes is that it provides ‘real time’ monitoring of requirements. Reporting facilities are also available such that the system can act as a tool to manage dealerships daily tasks.

This new showroom system, embodying the present invention, offers a modern approach to car retailing. From capturing events that a customer requests, as and when they happen, to being able to follow the process that the customer takes when searching for a vehicle. The new showroom system includes a unique database in which to record all events that occur.

Integrated Showroom is a complete real-time automotive retail solution. The system enables Managing Directors, for example, to see a true snapshot of how many leads and sales are being processed at that moment and then drill down into the actual “Events” to see exactly what the initiating user actually carried out. The unique combination of the CRC and personal pages actually allows drill-down to the screens and functionalities originally used by the customer or business user.

Integrated Showroom is a “clicks and mortar” car showroom facility. This means that a customer can choose to start their car buying process using the new technology—online (clicks)—or by the traditional method of walking into a dealership—(mortar). It means that a customer can then continue the full buying process—from comparative research to arranging a test drive, valuation of an old vehicle, arranging finance, purchase, delivery of the new vehicle through to exchange of an old vehicle—on the Internet, in the showroom or in a combination of both.

With Integrated Showroom every activity undertaken by a customer, whether online and/or in the dealership is recorded so that the dealers know what their customers are really looking for, have up-to-date correspondence and can proactively build a professional relationship.

As customers and dealers see the same interface on the Internet and on monitors in the dealership, there is a consistency of presentation and offers which enhances the dealership public image.

More specifically there are benefits for the customer, the dealership and the vehicle manufacturer as described below:

For customers the total car buying process is easier and offers more control to the customer leading to greater customer satisfaction. Also the strongly customer-centric product is the same online and within the showroom, reassuring customers that they are being offered the best deal.

For dealers there are benefits from better organisation and management of the process which is a key factor in successful sales. Also a dealer knows more about their customer's preferences than ever before from the moment they first make contact leading to better customer service. The organised and real customer information makes aftersales and re-sales easier and more personable.

The system also prompts and facilitates exemplary service offers which is a strong defense against solely online companies, grey imports and the ending of the Block Exemption. The same image and deal structure is provided wherever the customer chooses to visit—as above, this has to increase customer confidence in dealerships and improve their image.

For manufacturers recorded information about what consumers really want, buying influencers and then what the customer ends up buying is invaluable data generated for current supply and future car manufacture. Also an improvement in the image of dealerships has a positive impact on the image of manufacturers. An improvement in dealership sales through a strongly customer-centric product has a direct positive impact on manufacturers.

According to another aspect of the present invention there is provided a search engine arranged to carry out a search for a multi-dimensionally specified article, the search engine comprising: search request defining means for creating a search request comprising a multi-dimensional data specification regarding the desired features of the article; ranking means for ranking the responses in order of the degree to which the features of the response match the desired features of the request; and display means for presenting the ranked responses to the user for selection, the display means being arranged to indicate individual feature matching results for each of the requested features of the article such that the user is able to determine whether a lower ranked response is more suitable for selection.

The search engine according to this embodiment has the advantage of letting the user know how the ranking has been achieved. The displayed feature matching enables a greater depth of analysis to be carried out by the user when comparing search results. User preferences can change and combinations of the multi-dimensional data which may not have been anticipated may arise which can, using the present invention, be given consideration because of the displayed individual feature matching. An example of this in the car purchaser scenario is where a user is looking for a particular make and model of car with a specific engine size. The search results will find the closest match to the specified vehicle and this will be ranked the highest in the results. However, other makes and models of vehicles which also have common features may also be displayed showing the matching of the features. In this way a user can be made aware of other vehicles which they were not aware had similar specification to that required.

Preferably, each search result generated from the search request event is displayed together with an image of the vehicle. This aids in the faster interpretation of the search results as different colours and models of vehicle become evident at a much faster rate than would be the case with text based results only.

A preferred embodiment of the present invention will now be described by way of example with reference to the accompanying drawings.

### BRIEF DESCRIPTION OF THE DRAWINGS

FIG. 1 is a schematic block diagram of a system embodying the present invention;

FIG. 2 is a schematic block diagram showing the Integrated Showroom engine of FIG. 1 in detail;

FIG. 3 is a schematic block diagram showing some of the tables stored within the database of the system of FIG. 1;

FIG. 4 is a flow diagram showing the interaction between the different components of the system of FIG. 1;

FIG. 5 is screen shot of a search results page generated by the search module of the Integrated Showroom engine of FIG. 2 in response to a user's enquiry;

FIG. 6 is screen shot of a personal page screen generated by the personal page module of the Integrated Showroom engine of FIG. 2;

FIG. 7 is screen shot of a Customer Relations Controller page generated by the Customer Relations Controller of the Integrated Showroom engine of FIG. 2;

FIG. 8 is a flow diagram showing a process of applying broker logic to a request event;

FIG. 9 is a schematic table showing the basic organisation of a tCustomerEvents Record stored in the database of FIG. 3, when an event request is made;

FIG. 10 is a schematic table of the tCustomerEvents Record of FIG. 9 showing the outputs generated when a Category 1 (automated) event is carried out;

FIG. 11 is a schematic table of the tCustomerEvents Record of FIG. 9 showing further field settings generated by the system on initiating a Customer Business Functionality Unit as required by a Category 2 (non-automated) event; and

FIG. 12 is a schematic table of the tCustomerEvents Record of FIG. 11 showing two types of outputs which can be generated dependent on completion or cancellation of the Category 2 event.

### DETAILED DESCRIPTION OF A PREFERRED EMBODIMENT

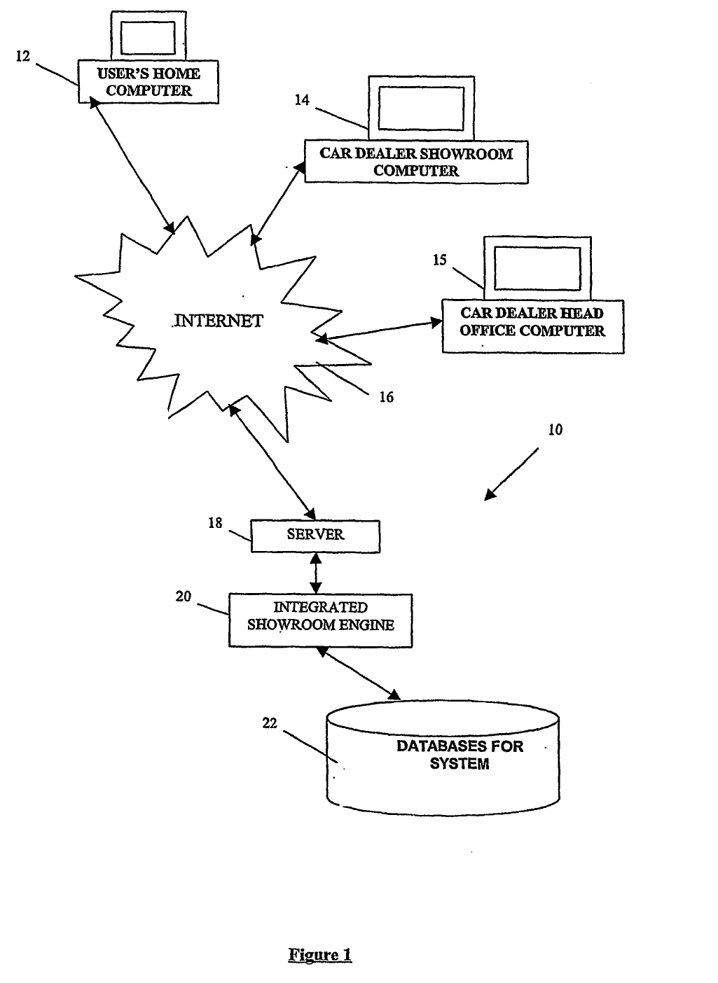

A complex process management and monitoring system 10 according to an embodiment of the present invention is shown in FIG. 1. The system in this embodiment is used to manage the complex process of car purchasing. The system 10 can be accessed by a customer from their home computer 12 or from a computer at a dealership showroom 14 via a wide area network, in this embodiment, the Internet 16. Also a salesperson at the dealership showroom computer 14 can also access the system 10 to see how the customer is progressing in the complex process and whether there are any manual tasks required to be carried out in response to a customer generated event request, which can advantageously help the sales process.

The system 10 comprises a Web server 18 for hosting a system Web site where information relating to the complex purchasing process can be stored, accessed and updated by the customer from the home computer 12, or by the customer or salesperson via the dealership computer 14. The system Web site is controlled by an Integrated Showroom engine 20 which carries out the relevant processing of data to enable monitoring of the complex purchasing process as well progressing customer generated requests for actions (known as ‘events’) which comprise a part of the overall process. Not all events can be completed automatically and so for events requiring some manual interaction, such as arranging a test drive, the salesperson will be prompted by the system to complete the event manually and then register the completion on the system. Furthermore, the Integrated Showroom engine 20 collects information on customer behaviour and generates reports. This can act as a tool in assisting the dealership to improve their service to the customer. Also a head office computer 15 connected to the system via the Internet 16 can see the activities of its various different showrooms 14 and assess their performance by accessing stored performance data at the system 10. In order to carry out these functions, the engine 20 has access to a suite of databases 22 for the dealerships and customers.

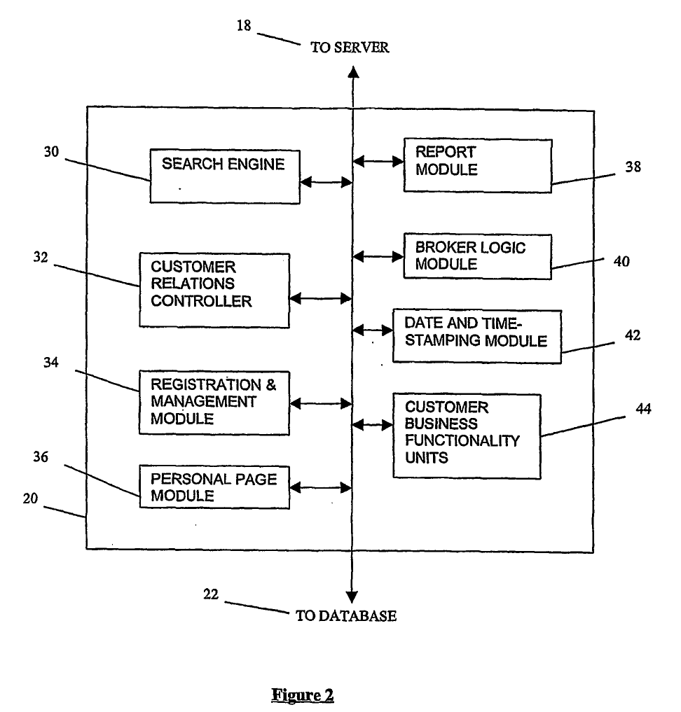

Referring now to FIG. 2, the Integrated Showroom engine 20 is divided into modules which make up a customer facing input section and modules which comprise a section fulfilling the customer requests (events). These events are stored in the databases 22 in a common data structure (tCustomerEvents) within XML messages as will be described in detail later.

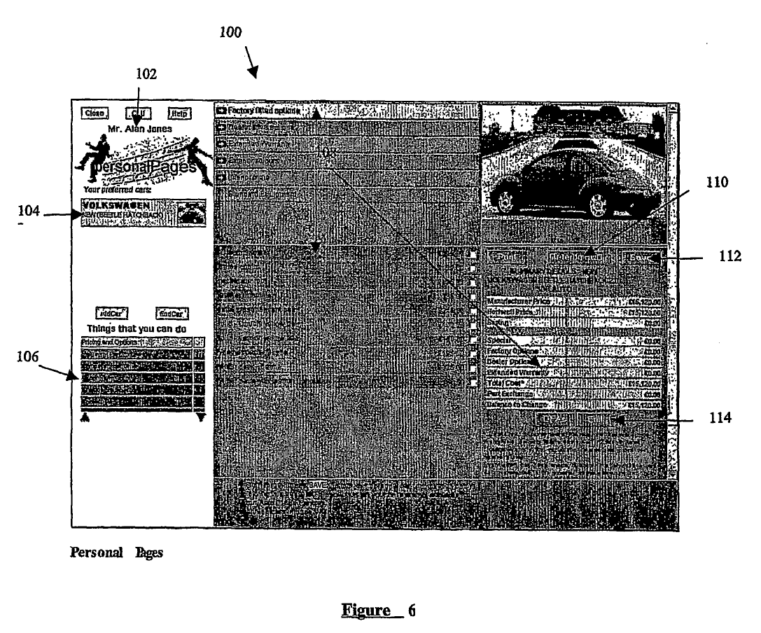

More specifically, the Integrated Showroom engine 20 comprises a search engine 30 for implementing a search event specified by the customer (such as a vehicle search) or even one specified by a salesperson at the dealer showroom 14 (such as a search for customer). The search engine 30 is arranged to carry out multi-dimensional data searches which are required to find relevant available vehicles. There are various fields for specifying the type of vehicle required, for example manufacturer, model, model types, price, body style, budget, transmission, fuel type, acceleration, number of doors, etc. Any of these can be specified to narrow down the search to the desired vehicles. The search engine 30 takes a user-specified search request and carries out a search of vehicle data stored in the database 22. The results are ranked on the basis of degree of correspondence of the multi-dimensional factors of the search specification to the specification of the vehicle. The ranked results are displayed to the user in a manner which will described in detail later with respect to FIG. 6.

Whilst not shown, the search engine 30 also comprises a People picker facility on the Integrated Showroom System where a salesperson can search for a customer either by their surname or postcode. The people picker facility also gives the salesperson the opportunity to edit new customer on the system and to search through the existing lists of customers. This facility is provided across an entire enterprise with multi-locations and this gives customer database transparency at each location.

The Integrated Showroom engine 20 also comprises a Customer Relations Controller (CRC) 32. The CRC 32 is the part of the System where the salesperson can view exactly what a customer has been doing whilst browsing the system Web site as well as any contact they have had with the salesperson's dealership. The salesperson can see which vehicles a particular customer has saved and any requirements they have specifically requested, for example a test drive or a brochure.

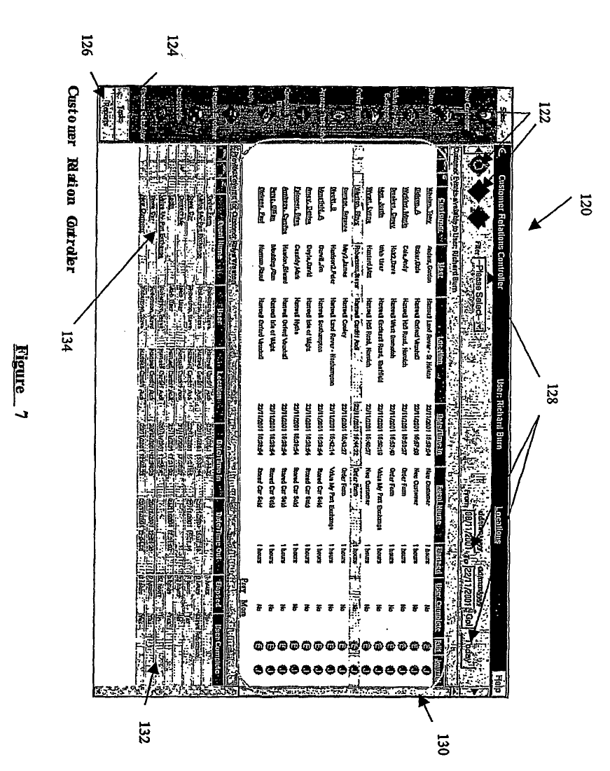

The CRC 32 collates and stores all events generated and handled by the system 10. Events are anything from storing a car to requesting a brochure. The term is also used to describe events that are current, for example outstanding events that need to be completed. The actual interface with the salesperson is described in detail later with reference to FIG. 7.

A registration and management module 34 is also provided to register the customers 12 that want to use the system 10 and the salespersons at the dealership 14. The customers and salespersons enter specific personal data about themselves e.g. address, which is used by the system 10 in profiling the users and assisting user searching. The module 34 also enables management of this personal data such that the data can be updated as required.

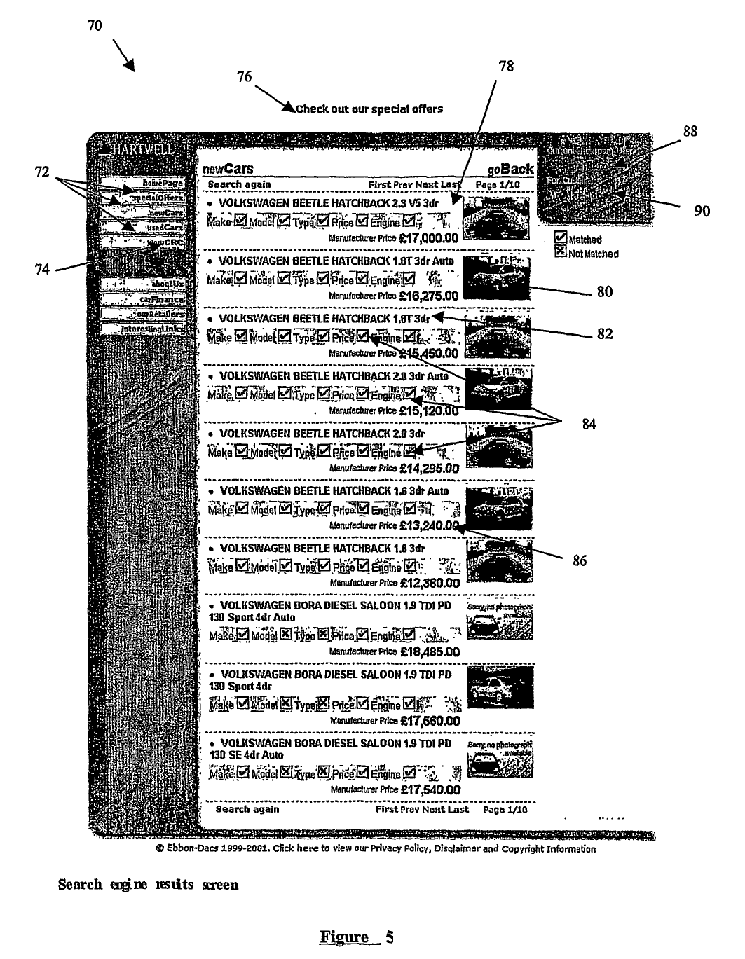

The personal pages module 36 creates for each customer registered on the system's website their own personalised part of the website called their ‘Personal Pages’. The vehicles the customer is interested in and the events they have done (e.g. Test Drive, Valued Part Exchange) can be stored against each customer individually. As the customer in the present embodiment has Internet access, they are able to access their own ‘Personal Pages’ from home and from the Dealership. The configuration of the Personal pages is described in detail later with reference to FIG. 5.

The Integrated System engine 20 also comprises a report module 38 for generating reports of the system's activities. The report module 38 has a comprehensive reporting suite which works with online system alerts to deliver vital management information in report format enabling Managing Directors, for example, to see a the snapshot of how many leads and sales are being processed at that moment. Reports on various aspects of how customers interact with the complex purchasing process are also generated and extremely useful to the retailer and also the vehicle manufacturer.

A broker logic module 40 is provided for controlling the access by different customers 12 and salespersons 14 to different events within the system 10. This is carried out by user of a series of permissions stored in the database 22, which can be updated to reflect changes in authorities for example. The broker logic module sits as an interface between the generated customer requests and the execution of those requests preventing unauthorised event processing. The way in which the broker module performs is described in detail later.

The Integrated Showroom engine 20 also comprises a time and date stamping module 42 specifically provided for time stamping each event that is generated in the system 10 and also each progression of an event towards completion. This module 42 is very important for the accurate functioning many of the other modules. For example it is important for the report generation module 38 as most if not all of the reports generated require time information to be included as a performance measure.

Finally, a suite of Customer Business Functionality Units (CBFUs) 44 are provided for implementing the customer specified events. There is one type of CBFU 44 for each type of request (event) that can be generated and each CBFU 44 controls the system's actions to complete an event.

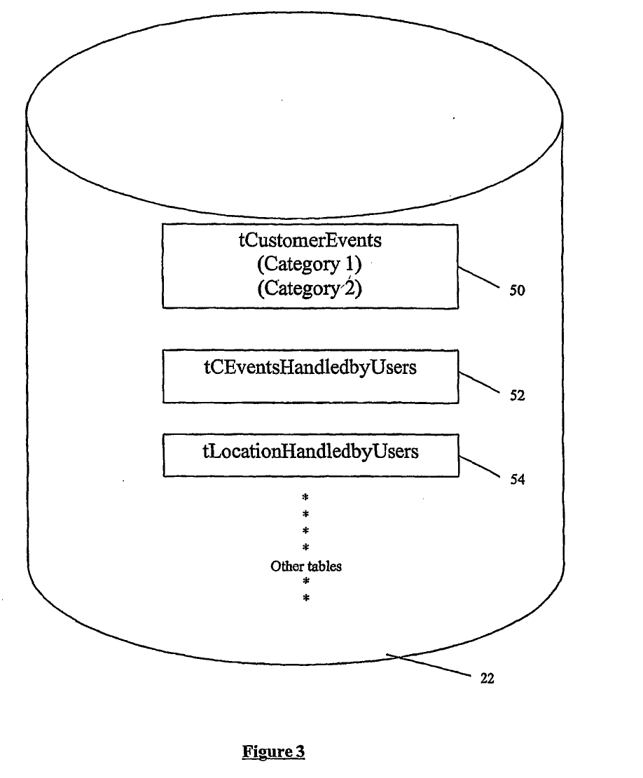

Referring now to FIG. 3, some of the data structures (arrays) stored within the. database 22 are now described. The database 22 includes a tCustomerEvents data structure (table) 50 for storing all customer generated events. The events stored in the tCustomerEvents data structure 50 fall into two categories, namely Category 1 where the events can be completed automatically without any manual interaction and Category 2 where each of these events requires some manual action to be taken in order to be completed.

Two further data structures are provided namely the tCEventsHandledbyUsers data structure 52 and the tLocationsHandledbyUsers data structure 54 together with the User detail tables (not shown). The tCEventsHandledbyUsers data structure 52 stores permissions for the each of the users to handle different types of events. Similarly, tLocationsHandledbyUsers data structure 54 stores locations where different salespersons' and other business users' practice such that a salesperson's suitability to interact manually with an event requiring some manual interaction can be determined. For instance, a salesperson may be mapped to ten events at one location, a follow-up centre operator to three events at twenty locations. A manager may also monitor both person's events for all the sites. A locking mechanism in the CRC prevents multi-users progressing an event concurrently. A user must release an event (being operated on by a Business Functionality Unit BFU) for another user to continue it. The way in which all three of these data structures 50, 52, 54 interact in providing permissions is described in detail later with reference to the broker logic module 40.

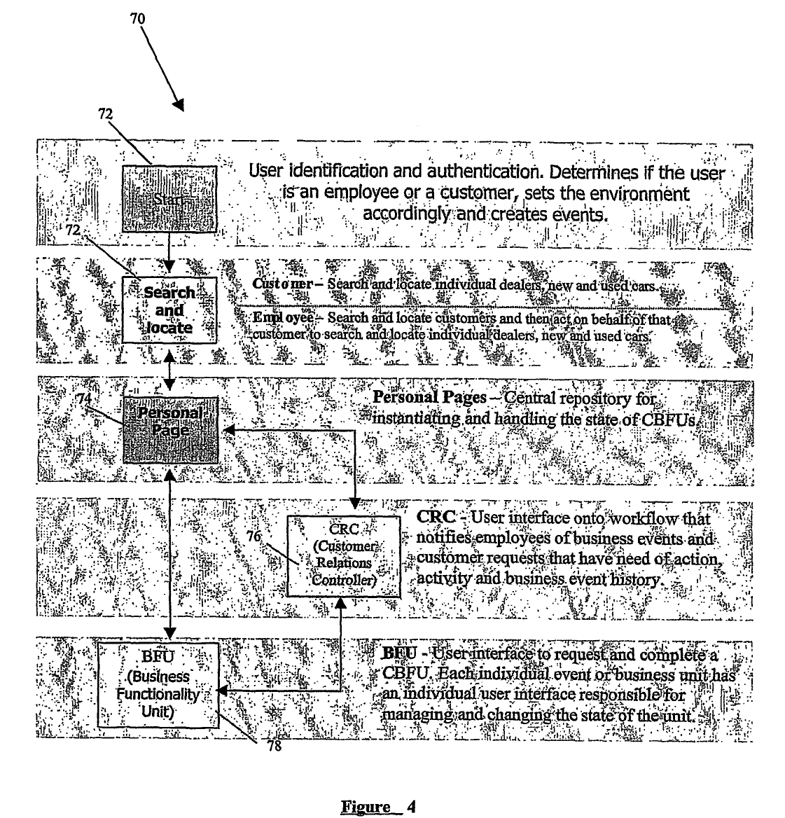

A method 60 of interacting with the integrated showroom system 10 is now described with reference to FIG. 4. Prior to the method commencing, the customer and the salesperson will have registered with the system 10 and the personal page for each customer will have been created. The method 60 commences with user identification and authentication at step 62. This identification determines the nature of the user, is he/she an employee of a registered company (a salesperson) or a customer? Determining this at an early stage governs how the system creates events, etc.

The next stage in the interacting process 60 is the search and locate process 64. This is different for the customer and the salesperson. The customer can use this process 64 to search and locate individual dealers and new and used cars. The salesperson uses this process 64 when the user visits the showroom and wishes to use the system. In this case, the system is used by the salesperson to search and locate a customer already registered with the system and then to act on behalf of the customer to search and locate individual dealers and new and used cars.

The results of searches can be stored on the user's personal page for future use by a personal page process 66. The personal page is a central repository for instantiating and handling the state of CBFUs and so typically the next stage in the interacting process 60 involves further events being initiated from the customer's personal page.

Events generated from the customer's personal page at process 66, result in an interaction process 68 with the CRC 32 which acts as a user interface onto workflow that notifies employees of business events and customer requests that have need of manual interaction. Also activity and event history is generated and stored in this process 68.

The last processing stage 69 of the overall process 60 occurs at the Business Functionality Unit (BFU) which has a user interface to request and complete CBFUs. Each individual event of business unit has an individual user interface responsible for managing and changing the state of the unit. This last stage can be accessed directly from the personal page process 66 or the CRC interaction process 68. Similarly, results of this process 69 and of the interaction process 68 are stored in the personal pages of the customer for current and future use.

Referring now to FIG. 5, a typical results page 70 generated in response to a search event is shown in detail. The page 70 comprises at one side thereof Hyperlinks 72 to search criteria screens, such as new cars, used cards, etc. A hyperlink 74 to a new CRC is also provided. At the top part of the page 70, there is a ticker tape 76 that displays user-defined news and special offer information. Most importantly, the page 70 lists the results 78 of the search in ranked order listing the vehicles which best match search criteria, ordered by those most suitable. Each search request result 78 includes a photograph 80 of the vehicle if one is available, a make and model descriptor 82, a series of individual feature matching indicators 84 which contain a tick or a cross to signify whether this feature of the search request result 78 matches the corresponding specified search request criteria, and a price indicator 86. The search results page 70 also displays the current logged in salesperson name 88, which acts as a hyperlink to a salesperson's record manipulation function. Similarly, the customer's name 90 is also displayed which acts as a hyperlink to the customer's personal page.

FIG. 6 shows a typical personal page 100 of a customer. The personal page 100 includes a hyperlink 102 to further customer derails which may have been stored on registration. There is also a list 104 of preferred vehicles for this customer including make and model information and a picture of the vehicle. It is possible to browse through the vehicles a customer has previously saved whilst visiting the system Web site. If the customer or salesperson clicks on a vehicle the customer has previously saved under the ‘preferred cars’ main menu, its pricing and options 108 will be presented, as is shown in FIG. 6.

A list of possible events 106 which the customer can generate from the personal page 100 is also provided. In this case, the possible events are: Pricing and Options, Arrange Test Drive, Value my Part Exchange, Finance Calculator, Request Brochure, Order Form and Contact Me for new cars and all the same except for the order brochure event for used cars.

The page also contains a hyperlink 110 to a finance and insurance tool, an option 112 to save details to customer page - typically for new information which has been added, and a save and edit costs option 114.

Referring now to FIG. 7, A CRC screen 120 is shown. As mentioned previously, The CRC 32 collates and stores events. Events can be described as anything from storing a car to requesting a brochure. The term is also used to describe events that are current, for example outstanding events that need to be completed.

The CRC screen 120 is split into several sections that are described in detail below.

At the top of the CRC screen 120 the name of the salesperson currently logged onto Integrated Showroom system (described as “User”) is located in the middle of the screen. There is also a text link on the right described as ‘Locations’. If the ‘Locations’ text link is selected, a box appears on the screen stating which dealership enquiries the user has access to.

The ‘Update Events’ text link at the top right hand side of the screen allows the user to update the CRC 32 with any events that have happened since your last update. For example, if the ‘Update Events’ text link is selected after the user has been working on the CRC 32 for an hour, the CRC 32 will automatically update any events that have occurred since the last time the user had used the ‘Update Events’ text link.

FIG. 7 actually shows a CRC default screen 120, which appears each time the user starts the CRC 32. When the user enters onto the CRC, they automatically see any events that are outstanding and need to be completed by the dealership (salesperson).

The default screen is split into a number of sections. The first section is the “Customer Events” section in the middle of the page and is split into columns as follows.
Messages (outgoing, incoming and internal)
Customer
User
Location
Date/Time In
Event Name
Elapsed
User Complete
Edit and Journal buttons

There are three parts to the message column. These are:
Message To Customer (outgoing)
Message Prom Customer (incoming)
Internal Message

Different colour ticks under the messages column show the messages between the customer and the dealership. The ticks are red, green and black in colour depending on the type of message.
Red tick=Message sent from current Showroom User
Black tick=Unread message from the customer
Green tick=Acknowledged message from customer

The ‘Customer Column’ lists the customer surname with the most recent enquiry at the top of the list. The ‘User’ Column lists the last person to action the event i.e. which salesperson carried out the last task for that particular customer. If the User is listed as “Web User” then the customer is a web-based customer.

The ‘Location’ column lists the dealership that the user has requested the information from i.e. the one that is closest or most convenient for them. The ‘Date/Time in’ column logs the time that the event was requested. The ‘Event Name’ column indicates which event the customer has requested e.g. Arrange Test Drive. The ‘Elapsed’ column records the amount of time that has elapsed since the customer made their enquiry. The ‘User Complete’ column states whether the event has been completed or not by indicating ‘yes’ or ‘no’ within the column. The ‘Edit’ button allows you to go into the customer's record card. Once you have clicked on the ‘edit’ button you are able to edit any customer details that are incorrect or require updating. The ‘Journal’ button allows you to view the ‘Journal’ page of a Customer Record Card (setup on registration—not shown).

The default screen is split into a number of sections. There are two events buttons 122 found on the top left hand side of the screen 120, namely and All Events button 122 and an Outstanding Events button 122.

Also a link to a salesperson scheduler 124 is provided as is a link to reports 126. The time, location and person filter 128 provides its results in the main customer events window 130 of the screen 120. A previous events section 132 is provided with links 134 to the corresponding business functionality units.

When a user enters the CRC screen 120, they have the option by selecting the All Events button 122 to access all events that have taken place between any customer and the salesperson's dealership.

When a user enters the CRC screen 120 the ‘Outstanding Events’ button 122 is automatically activated. The ‘Outstanding Events’ button 122 highlights any events that have not yet been completed by the dealership. Therefore ‘No’ will be seen in the user complete column.

If the user wishes to narrow down a customer search or look for something in particular, such as a date range or type of event, there are a number of filtering options 128 on the CRC screen 120 that can be used. There are three filter facilities that are available for use and they can all be used at the same time if required.

Filter 1 contains a drop down box, which enables you to search by the following options:
Customer Name
Postcode
User Name
Location
Elapsed Time

For example if by ‘Elapsed Time’ is selected, the user can enter a time and press “Go!” to return only events that are older than that time. For example, if the user enters 2 hours in the text box provided and then clicks on the ‘Go!’ button; a page will be displayed showing all the events that have been outstanding for 2 hours or more.

Filter 2 allows a more thorough search to be conducted by date range. If the user enters the date ranges by which the user wishes to search and clicks on the ‘Go!’ button, this will bring up all the ‘Outstanding Events’ within the date range entered.

More advanced searches can be carried out by combining filters 1 and 2. For example if a customer's name is entered within the text box, for example the surname Polson, and then a date range is entered within filter 2, the user can search for all the ‘Outstanding Events’ for that customer within the date range entered.

A ‘Clear Filter’ button is provided to clear any filters previously activated. Once the ‘Clear Filter’ button has been activated the user is retimed to the outstanding events screen. A ‘Today’ button clears Filter 2 back to today's date. Once the ‘Today’ button has been activated, the user is returned to all the outstanding events for the current day.

Filter 3 is provided by the use of the buttons 122 in the list on the left of the screen for narrowing down the search even filter. For example, by selecting the ‘Test Drive’ button only test drive requests in the Customer Events section win be seen. This can be used in conjunction with filters 1 and 2 or on its own.

The CRC default screen 120 also has buttons 122 within the left-hand menu. These are the events that a customer can request whilst browsing on the Web and act as filters. However, not all of the events are completed by the dealership.

The events that a customer can request are:
Store Car
Request Brochure
Arrange Test Drive
Contact Me
Value My Part Exchange

Events the customer can view are:
Finance Calculator

The events that a dealer can carry out and complete at the dealership are:
Store Car
Arrange Test Drive
Request Brochure
   Value my Part Exchange
Order Form
Contact Me

The salesperson cannot complete the following events as they auto-complete when the customer requests them.
Finance Calculator

The Event Filters 122 are described below.

It is to be appreciated that the filters 122, which filter on the type of event, are dynamically available when a new event is set up in the system. They are therefore subject to change.

If the user clicks on the ‘Store Car’ button when the ‘All Events’ button is activated all the customers who have stored a car from your dealership will be shown on the CRC page.

If the user clicks on the ‘Request Brochure’ button whilst in the ‘Outstanding Events’ mode, a list of customers requiring a brochure will be shown.

If the user clicks on the ‘Arrange a Test Drive’ filter whilst in the ‘Outstanding Events’ mode the CRC will show all the customers who have requested a test drive at that dealership but who have not yet had a test drive date confirmed.

If the user clicks on the ‘Test Drive Complete’ filter whilst in the ‘Outstanding Events’ mode, events are shown for customers who have completed booking their test drive but have not actually had it yet. In ‘All Events’ mode, the completed test drives are shown as well.

If the user clicks on the ‘Value My Part Exchange’ button when the ‘All Events’ button is activated a screen will appear displaying all the customers who have requested a valuation for their vehicle.

If the user clicks the ‘Contact Me’ button a list of customers who have left messages for the dealership via their Personal Pages will be shown,

If the user clicks on the ‘Finance Calculator’ button when the ‘All Events’ button is activated a list of customers who have used the finance calculator will be displayed.

If the user clicks on ‘Order Form’ whilst in ‘Outstanding Events’ mode, current orders for cars that have not yet been delivered are shown. If the user clicks on ‘Order Form’ whilst in ‘All Events’ mode, then delivered vehicle will also be shown.

A ‘New Customer’ event is generated when a customer's details are added to the system for the first time. The event will show as ‘Outstanding’ until a vehicle has been stored against that customer. When a vehicle is stored against the customer, the ‘New Customer’ event will automatically complete.

A ‘Login’ event is generated when a customer logs in to their personal pages via the web. The event will complete immediately, so will only show in the CRC when it is in ‘All Events’ mode. The purpose of this event is to inform the showroom user of customer's viewing their personal pages, but without doing any further events.

Once the customer's personal page has been reached, the ‘Contact Me’ text link is selected under the ‘Things that you can do’ menu and the salesperson is taken to the customer's ‘Contact Me’ page. Here the salesperson simply writes in your message within the text box and clicks on the ‘Send’ button. Once this has been done, the salesperson will have introduced themselves and offered help if the customer requires any further information.

Therefore, that the ‘Contact Me’ facility can be used at any time to correspond with any customer who has registered on the system.

To complete an outstanding test drive request, firstly the event from Customer Events/Previous Events is selected. Selecting ‘Test Drive’ option 134 in the Previous Events section 132 of the CRC page 120 opens up a test drive page in the customer's Personal Pages.

At this particular point the user can either complete the request by clicking on a ‘Confirm with Customer’ button (not shown) or delay responding to the request by clicking on the ‘Reschedule for Later’ button (not shown).

Once the salesperson has completed the message that is to be sent to the customer, the ‘Send’ button is selected and the message appears in the box at the top of the screen. Any correspondence that the salesperson has exchanged with the customer appears in that box. Once the salesperson is happy with the sent message, the ‘Continue’ button is selected and a new screen appears confirming that the test drive has been arranged. The salesperson then selects the ‘Continue’ button to return to the CRC.

Returning now to the broker logic module 40, this module is arranged to handle two different types of events in the system namely: Customer events where there is no associated CBFU 44, but the events are still written to the tCustomerEvents data structure 50 for database recording purposes; and Customer events where there is a corresponding CBFU 44, which will also be stored in the tCustomerEvents data structure 50 but need a process to be carried out by a valid user in order to complete the event.

These two types of events are stored result in two categories of events being stored in the tCustomerEvents data structure 50:
Category 1
   Store Car to Personal Pages (including configuration)
   Appraisal
Category 2
   Test Drive Request
   Brochure request
   Contact Me
   Buy Me
   Finance

The Broker logic module 40 has a simple function to perform. For all events in Category 2 of the tCustomerEvents data structure 50 (i.e. needing a human process, such as confirming a test drive date or configuring a finance deal), it checks whether the currently logged in user has the correct permission to execute the event. If they have, it will call the corresponding CBFU 44. However, if they have not, the broker logic module will display an instant response message notifying the user of the lack of permission.

The reason for providing this degree of access control to the system functions in a Point of Sale application is now explained. One has to consider the two types of user of the system 10: a web user 12 and showroom user 14. Obviously, a web user 12 will not be able to schedule their own test drive request for example, even though they can certainly request it. Also, a Web user 12 cannot finalise their finance deal, even though they can fill in the input request However, as the same system 10 can be accessed via the showroom computer 14, then some of these limitations can be removed such that the user will be able to carry out certain processes to completion. For instance, a sales representative standing in front of the customer can input the test drive request, but they are also able to confirm the date and time of the test drive as they have authority to do so.

If, however the sales representative supervises and enters the finance deal with the customer, the car dealership may not wish them to finalise the finance, and so the system can be configured to ensure that this function can only be completed by a separate Finance manager or a central office. In this case, the sales representative would be able to fill in the finance request form. However, the system 10 would see that they did not have the appropriate permissions to complete the financing event and so a response message notifying them of this fact would be displayed. The salesperson would thus not be allowed access to the corresponding financing CBFU 44.

At this point the Customer Relations Controller 32 is used. The controller 32 continuously parses the tCustomerEvents data structure 50 for events that have an input request, but no output, namely are incomplete. For a user with the correct permissions, the CRC 32 allows them to call the corresponding CBPU 44 for a particular event request and complete the output. This is then reflected in the Personal Pages of the customer and the customer is notified by e-mail. Effectively, the split of input, process and output in the present embodiment allows the system 10 to shift processes around the users, whether they are customers or their representatives, as it requires. As the CRC has a multi-user, multi-event capability, it is also possible that other managing (controlling) users can observe progress of these events for their mapped sites and intercede (via telephone or the provided internal messaging) if no progress is made. They will usually be mapped to many sites and run a filter (e.g. all sites where a test drive request was not completed in less than two hours).

The broker logic module 40 is linked to the two relevant data structures, namely the tCEventsHandledbyUsers data structure 52 and the tLocationsHandledbyUsers data structure 54 together with the User detail tables (not shown). A maintenance application run on the broker logic module 40 controls who can do what and from where across a multi-location enterprise. The front end Personal Pages 36 and CBFU's 44 simply obey the logic set up in these tables 52, 54.

The way in which the broker logic module 40 functions in conjunction with the tCEventsHandledbyUsers data structure 52 and the tLocationsHandledbyUsers data structure 54 is best illustrated by way of a simple example.

### EXAMPLE

George is a finance manager and has a User_ID of 546

Fred is a salesperson and has a User_ID of 1023

The CEvent_id 7 stands for Finance Request

The CEvent_id 2 stands for Test Drive Request

George (User_ID 546) handles locations:
1=Oxford
2=Southampton
3=Brighton

Fred (User_DD 1023) works at one branch:
2=Southampton

The following table allows this logic:

George is the only user with access to the Finance Event CBFU 44. Fred (the salesperson) would only be able to fill in the input. On clicking for the corresponding CBFU 44, he would get back the AutoMessage only notifying him of the lack of permission for this process.

Fred can use the CBFU 44 for the Test Drive Event. He has access to the CBFU 44 and can progress it. George would use the Customer Relations Controller 32 and would be able to see Test Drive events (User_ID 546 has an entry for CEvent_ID=2), but could not call the CBFU 44, as the Can Progress field is set to No. It is to be appreciated that no CBFU 44 can be used by a user unless the CanProgress field for that user is set to True.

The table entries for this logic are as follows:

tLocationsHandledbyUsers

| Key | User_ID | Location_ID | Notes |
|---|---|---|---|
| (n) | 546 | 1 | Handles three |
| (n + 1) | 546 | 2 | Locations |
| (n + 2) | 546 | 3 | |
| (n + 3) | 1023 | 2 | Handles one location |

tEventsHandledbyUsers

| | | | Can_Pro- | |
|---|---|---|---|---|
| Key | User_ID | CEvent_ID | gress | Notes |
| (n) | 546 | 7 | Y | Progress Finance |
| (n + 1) | 546 | 2 | N | Monitor TestDrive |
| (n + 2) | 1023 | 2 | Y | Progress TestDrive |
| (n + 3) | 1023 | 7 | N | Input Finance only |

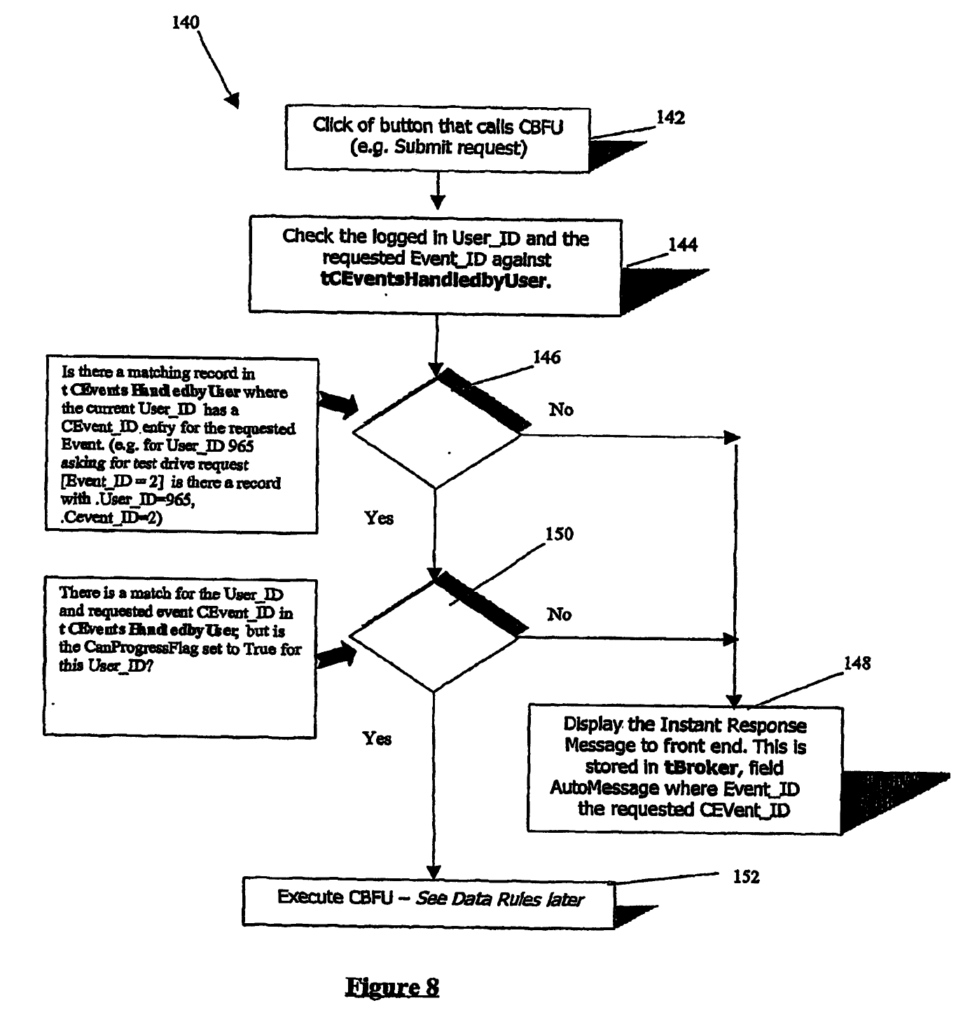

Referring now to FIG. 8, the Broker Logic Request Flow is shown. For each of the events in Category 2 (having separate CBFUs 44) the following logic applies.

The process 140 commences at Step 142 by a user clicking on a button that initiates a call to the appropriate CBFU 44, e.g. submit request. At this stage, the broker logic module 40 obtains at Step 144 the logged on User_ID and the requested Event_ID and retrieves the permissions stored in the tCEventsHandledbyUser data structure 52 corresponding to that User_ID and Event_ID. The retrieved permissions are checked at Step 146 and if the current user does not have the appropriate permissions to handle this type of event, the broker logic module 40 prompts the system 10 to display at Step 148 the instant response message to the user that permission for handling this activity by this user is not available. The message is stored in a database 22 stored tbroker data structure (not shown) that comprises different messages for different events. The field for accessing the correct message is determined by the Event_ID.

If however, the current user does have permission for handling this event as determined by Step 146, then a further check is carried out at Step 150 to determine whether the user has permission to complete the event. This is done by checking the CanProgress flag in the tCEventsHandledbyUser data structure 52 for this event and user. If the flag is not set, the broker logic module 40 prompts the system 10 to display at Step 148 the instant response message to the user that permission for completing this activity by this user is not available. Otherwise, if the flag is set, then the process 140 goes onto to execute at Step 152 the corresponding CBFU 44.

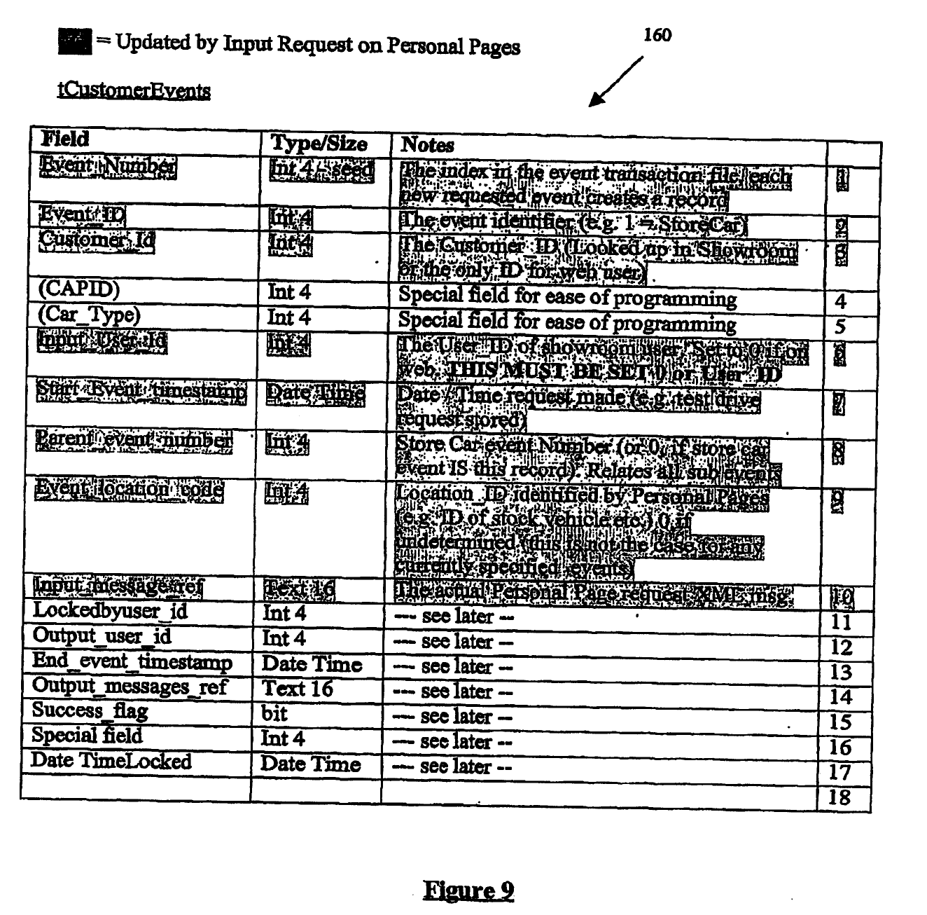

Referring now to FIGS. 9 to 12, the way in which event data input from the Personal Pages (via the Personal Page Module 36) is stored is now described. It is known from what has been described above that Customer Event processes are separated from input and output. For this to work in practice and tie in with the Customer Relations Controller (CRC) 32, all event data must be written in a standard manner. This is all handled by Customer Events. The requirements are very similar for the Category 1 (no back end process) and Category 2 (with backend process) events. Each front end event request must output to the fields highlighted in FIG. 9 of a tCustomerEvents record 160 in the tCustomerEvents data structure 50.

The input request enters the data into the fields of the tCustomerEvents record 160 highlighted in FIG. 9. This is effectively a time-recorded message with details of the requesting customer and supervising user. (Note this is zero in the case of the Internet with no User_ID).

For Category 1 events (Store Car/appraisal etc) the system 10 carries out the process in front of the user, i.e. it is not a request for further processing. For these automatic events, certain fields of the tCustomerEvents record 160 have to be filled in by the system 10. This is so that the back end Customer Relations Controller 32 can see these events as successfully completed and not outstanding. This is important as this control runs generally across all events and simply parses the tCustomerEvents data structure 50, to see the ‘Events Outstanding’ and ‘Events Completed’ status.

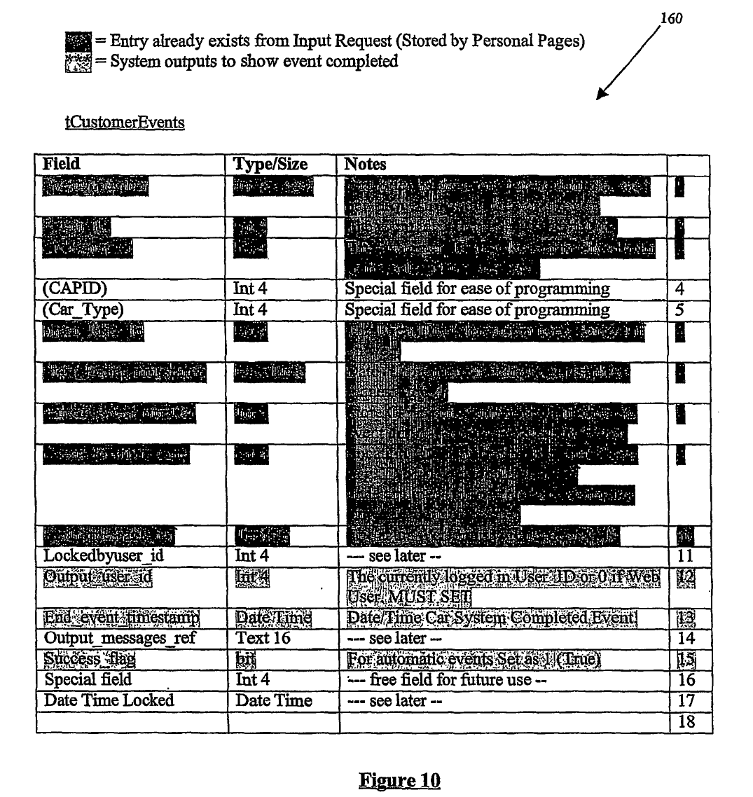

For the Store Car to Personal Pages and the Appraisal (the only Category 1 events in the present embodiment) the system 10 sets the data output fields highlighted in FIG. 10 on completion (i.e. at the end of the storage code). The data here is used for generating data output from the record 160 in due course.

Data output required by. Category 2 events, have slightly different requirements than those of Category 1. This type of event requires a user to access the CBFU 44 and carry out an activity, before the output message can be created. For instance:
Using the CBFU 44 to confirm a test drive event, therefore creating an output XML message;
Using the CBFU 44 to configure a Finance Deal.

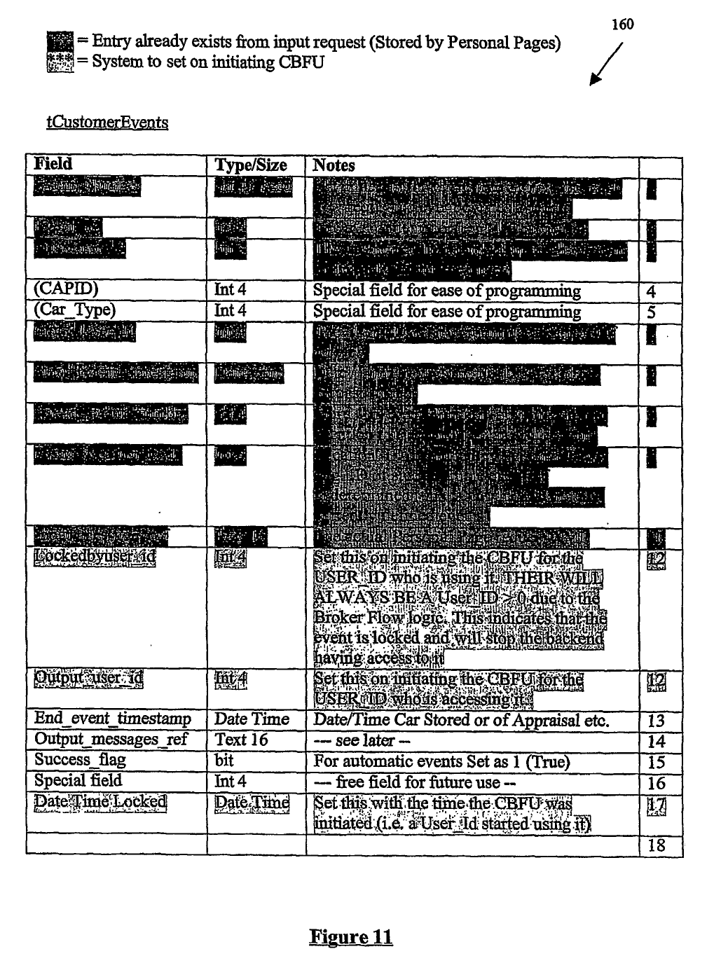

The highlighted data shown in FIG. 11 needs to be added to the tCustomerEvents record 160 when the CBFU 44 has been successfully called. Note that this is only applicable after the Broker request flow is successful and the CBFU 44 is called. There is therefore: a Customer_ID and a valid User_ID who has the relevant CEvent_ID in their tEventsHandledbyUsers with CanProgress set to Yes against them in the same data structure. Also the first fields have to be set on initiating the CBFU.

The fields shown in FIG. 11 are set on starting the CBFU 44. The user will then use the CBFU page/s to carry out a process; as a simple example this would be confirming the test drive request date/time. There are two possibilities for most CBFUs 44:
1) The user cancels and the output is not completed
2) The user completes the work and the output message is created

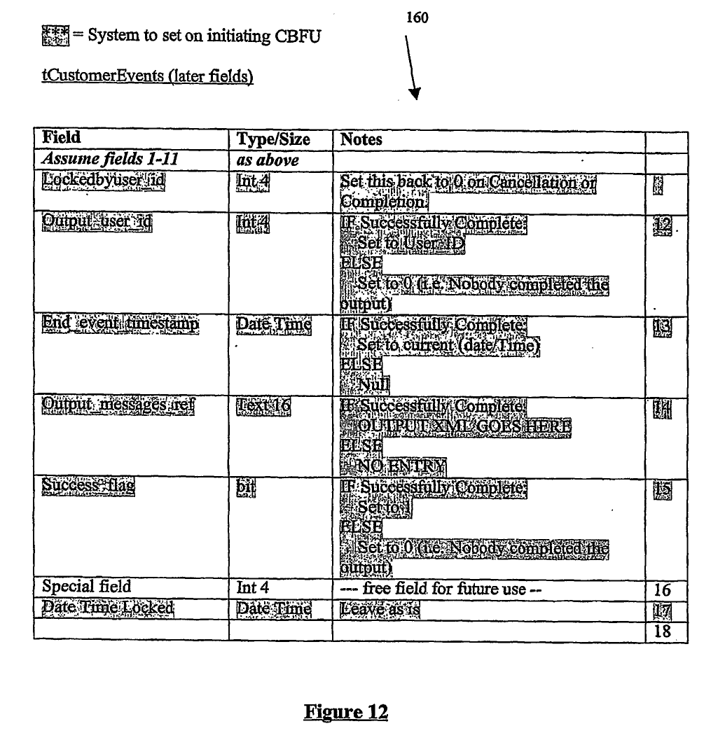

These two circumstances have to be handled to inform the back end control (CRC 32) of the event status. The code involved with this and the message itself will depend on the individual CBFU 44. The common data output on these two conditions is set out in the record 160 shown in FIG. 12. Note the database 22 has to ensure that the event is also unlocked on cancellation or completion.

This procedure therefore handles completing a tCustomerEvent record 160 for an Event completing successfully (with message) or being cancelled by the user. This process keeps the integrity with the back end Customer Relations Controller which is also capable of calling the CBFUs 44 to carry out confirmations and processes away from the Point of Sale.

These events may also have associated dialog. This will be entered into a tCustomerEventsDialog database structure (not shown) and associated with the same unique Event_Number.

Having described a particularly preferred embodiment of the present invention, it is to be appreciated that the embodiment in question is exemplary only and that variations and modifications such as will occur to those possessed of the appropriate knowledge and skills may be made without departure from the spirit and scope of the invention as set forth in the appended claims. For example, the present invention is not restricted to managing the purchase of vehicles, any multi-dimensionally specified article can be the subject of the present invention such as a new house or building which is being built to a detailed specification. Furthermore, even though the present invention has been described in relation to a single user and a single dealership, it is to be appreciated that the system is specifically designed to operate with multiple users and locations (dealerships, centres, homes and all outsourced operations). In fact, it is when the system becomes heavily used that its attributes and advantages are most clearly seen.

1-25. (canceled)

26. An on-line multi-channel workflow processing system for managing and monitoring the progression of a complex multi-event process such as an automobile purchasing process, the system comprising:
capturing means for capturing events requested by a first user, the capturing means being arranged to create and store an event record for each event;
implementing means, operatively coupled to the capturing means, for implementing at least some of the events automatically;
listing means, operatively coupled to the capturing means, for listing the event record of each event requiring manual interaction for completion and which has yet to be completed; and
updating means for updating the stored event record when a second user has manually progressed the event towards completion.

27. A system according to claim 26, wherein the capturing means comprises data input means for inputting details of the event into the event record.

28. A system according to claim 27, wherein the data input means is arranged to input and store data describing the first user.

29. A system according to claim 26, wherein the implementing means and the updating means are arranged to store the results of an implemented event within the corresponding event record.

30. A system according to claim 26, wherein the implementing means and the updating means are arranged upon completion of an event to update the event record in real time.

31. A system according to claim 26, wherein the listing means is arranged to display a list of all event records and to indicate whether they have been completed or not.

32. A system according to claim 26, wherein the listing means is arranged to filter events according to criteria selected by the second user.

33. A system according to claim 26, further comprising a time and date stamping module, the time and date stamping module being arranged to time and date stamp each event and each change in status of that event.

34. A system according to claim 33, wherein the listing means is arranged to display a list of the time and date of the creation of each event request.

35. A system according to claim 33, wherein the listing means is arranged to calculate and display the time lapsed since the creation of the event request.

36. A system according to claim 26, wherein the listing means is arranged to display the location of the user instigating the event request.

37. A system according to claim 26, further comprising a categorising means for categorising the events into an automated category and a manual interaction category.

38. A system according to claim 26, further comprising a broker logic module for determining the permission of the first user and the second user to access and update different events.

39. A system according to claim 38, further comprising a database of stored permissions relating to each user and relating to each type of event, the broker logic module being arranged to access the database to determine the permissions.

40. A system according to claim 26, further comprising a personal location management means for storing all of the first user's interactions with the system at a personal location on the system, the personal location management means being arranged to provide the stored user interactions to the first user or to the second user at a later point in time.

41. A system according to claim 40, wherein the personal location management means is arranged to store a history of the results of the user requested events.

42. A system according to claim 26, further comprising presenting means for presenting the user with a list of the different requestable events available to that user.

43. A system according to claim 26, further comprising communication means for communicating with the users via a wide area network.

44. A system according to claim 26, further comprising a search engine for implementing search request events.

45. A method of implementing an on-line multi-channel workflow process for managing and monitoring the progression of a complex multi-event process such as an automobile purchasing process, the system comprising:
capturing events requested by a first user, the capturing step comprising creating and storing an event record for each event;
implementing at least some of the events automatically;
listing the event record of each event that requires manual interaction for completion and which has yet to be completed; and
updating the event record when a second user has progressed the event towards completion.

46. A search engine arranged to carry out a search for a multi-dimensionally specified article such as an automobile purchasing process, the search engine comprising:
search request defining means for creating a search request, the search request comprising a multi-dimensional data specification regarding the desired features of the article;
ranking means for ranking the responses, generated in response to execution of the search request on the search engine, in order of the degree to which the features of the response match the desired features of the request; and
display means for presenting the ranked responses to the user for selection, the display means being arranged to indicate individual feature matching results for each of the requested features of the article such that the user is able to determine whether a lower ranked response is more suitable for selection.

47. A search engine according to claim 46, further comprising communications means arranged to support communications with a user to create a request and to provide the ranked responses to the request.

48. A search engine according to claim 46, wherein the display means is arranged to indicate individual feature matching results for each of the requested features of the article by use of simple tick symbols and cross symbols against each of the displayed features.

49. A search engine according to claim 46, wherein the display means is arranged to display image data relating to each ranked response.

50. A system according to claim 43 further comprising a search engine comprising:
search request defining means for creating a search request, the search request comprising a multi-dimensional data specification regarding the desired features of the article;
ranking means for ranking the responses, generated in response to execution of the search request on the search engine, in order of the degree to which the features of the response match the desired features of the request; and
display means for presenting the ranked responses to the user for selection, the display means being arranged to indicate individual feature matching results for each of the requested features of the article such that the user is able to determine whether a lower ranked response is more suitable for selection.

51. An on-line multi-channel workflow processing system for managing and monitoring the progression of a complex multi-event process such as an automobile purchasing process, the system comprising:
an event capturer for capturing events requested by a first user, the event capturer being arranged to create and store an event record for each event;
an event implementer, operatively coupled to the event capturer, for implementing at least some of the events automatically;
an event record lister, operatively coupled to the event capturer, for listing the event record of each event requiring manual interaction for completion and which has yet to be completed; and
an event record updater for updating the stored event record when a second user has manually progressed the event towards completion.

52. A search engine arranged to carry out a search for a multi-dimensionally specified article such as an automobile, the search engine comprising:
a search request definer for creating a search request, the search request comprising a multi-dimensional data specification regarding the desired features of the article;
a ranker for ranking the responses, generated in response to execution of the search request on the search engine, in order of the degree to which the features of the response match the desired features of the request; and
a display for presenting the ranked responses to the user for selection, the display being arranged to indicate individual feature matching results for each of the requested features of the article such that the user is able to determine whether a lower ranked response is more suitable for selection.

53. An on-line multi-channel workflow processing system for managing and monitoring the progression of a complex multi-event process such as an automobile purchasing process, the system comprising:
capturing means for capturing events requested by a first user, the capturing means being arranged to create and store an event record for each event;
implementing means, operatively coupled to the capturing means, for implementing at least some of the events automatically; listing means, operatively coupled to the capturing means, for listing the event record of each event requiring manual interaction for completion and which has yet to be completed; and
updating means for updating the stored event record when a second user has manually progressed the event towards completion; wherein the implementing means and the updating means are arranged upon completion of an event to update the event record in real time.

54. An on-line multi-channel workflow processing system for managing and monitoring the progression of a complex multi-event process such as an automobile purchasing process, the system comprising:
capturing means for capturing events requested by a first user, the capturing means being arranged to create and store an event record for each event;
implementing means, operatively coupled to the capturing means, for implementing at least some of the events automatically;
listing means, operatively coupled to the capturing means, for listing the event record of each event requiring manual interaction for completion and which has yet to be completed;
updating means for updating the stored event record when a second user has manually progressed the event towards completion; and
a time and date stamping module, the time and date stamping module being arranged to time and date stamp each event and each change in status of that event; wherein the listing means is arranged to display a list of the time and date of the creation of each event request and to calculate and display the time lapsed since the creation of the event request.
